(19) United States
(12) Patent Application Publication
(10) Pub. No.: US 2009/0089322 A1
(43) Pub. Date: Apr. 2, 2009

(54) LOADING PREDICTED TAGS ONTO ELECTRONIC DEVICES

(76) Inventor: Mor Naaman, San Francisco, CA (US)

Correspondence Address: MORRISON & FOERSTER LLP, 755 PAGE MILL RD, PALO ALTO, CA, 94304-1018, US

(21) Appl. No.: 11/864,828

(22) Filed: Sep. 28, 2007

(51) Int. Cl. G06F 17/30

(52) U.S. Cl. 707/103 R; 707/E17.055

(57) ABSTRACT

A tag generation apparatus preloads tag rules onto a peripheral device. The apparatus includes tag generation logic for generating a tag rule. The predicted tag rule is generated based upon information received from a data source, and the tag rule, when executed, associates a tag name with a content object in response to the content object satisfying the tag rule. The apparatus also includes tag communication logic for communicating the tag rule to the peripheral device for storage in a memory located on the peripheral device. The apparatus may be included in a host computer. A tag association apparatus includes tag receiving logic for receiving a tag rule that includes a tag name, tag storage logic for storing the at least one tag rule in a memory; and tag association logic for associating the tag name with a content object in response to the content object satisfying the tag rule.

### BACKGROUND

1. Field

The present application relates generally to the association of tags with information objects, and more specifically to preloading selected tags onto devices.

2. Related Art

User-supplied tags, or textual labels assigned to content, have been a powerful and useful feature in many social media and Web applications, such as Flickr®. In general, tagged content is more useful to a user than untagged content because the tags provide an efficient means for organizing, searching, and correlating various types of content, such as videos, photographs, and audio recordings. Services such as Yahoo!® ZoneTag allow a mobile device to upload and tag photos taken with the device. The tags are generated on a host server using attributes of the content. For example, the device may communicate with a server via a network every 15 minutes to download tags for images. In these systems, the device relies on the server to provide the tags and must make a network connection to the server to generate the tags.

Since the existing systems use a network connection between the server and the mobile device, the device must establish a network connection to use tagging logic to generate tags for photos or images. It would be desirable to have a system and associated method for loading tags onto peripheral devices that are not directly connected to tagging system.

### SUMMARY

In general, in a first aspect, the invention features a tag generation apparatus for preloading tag rules onto a peripheral device. The apparatus includes tag generation logic for generating at least one tag rule, wherein the at least one tag rule is generated based upon information received from a data source, and the at least one tag rule is operable to associate a tag name with a content object in response to the content object satisfying the at least one tag rule, and tag communication logic for communicating the at least one tag rule to the peripheral device for storage in a memory located on the peripheral device.

Embodiments of the invention may include one or more of the following features. The information may include an image, video, audio, a calendar entry, a transaction record, a geographic location, input data provided by a user of the peripheral device, an existing tag, or a combination thereof. The input data may include a location name, an event name, a person's name, a landmark name, or a combination thereof. The geographic location may include a place referenced in an operation performed on the peripheral device. The operation may include a transaction, a display of information, a global positioning system query, or a combination thereof. The tag name may include text, graphics, audio, or a combination thereof.

In general, in a second aspect, the invention features a tag association apparatus for associating tags with content objects. The apparatus includes tag receiving logic for receiving at least one tag rule, wherein the at least one tag rule includes a tag name, a memory for storing the at least one tag rule, tag storage logic for storing the at least one tag rule in the memory, and tag association logic for associating the tag name with a content object in response to the content object satisfying the at least one tag rule.

Embodiments of the invention may include one or more of the following features. The tag association logic may be operable to store an association between the tag name and the content object in the memory. The apparatus may further include tag selection user interface logic for displaying the tag name, wherein the tag selection user interface logic is operable to cause the tag association logic to establish an association between the tag name and the content object in response to a user accepting the association between the tag name and the content object. The tag association logic may be operable to associate the tag name with the content object in response to receiving the content object from a content generator and the content object satisfying the at least one tag rule. The at least one tag rule may include a logical expression having at least one variable, and the tag association logic may be operable to associate the tag name with the content object in response to the logical expression being true. The at least one variable may represent at least one attribute of an image. The at least one attribute may include a date, a time, a place, a feature of the image, or a combination thereof. The at least one variable may represent at least one graphical characteristic of an image. The at least one graphical characteristic may include a defined pattern, a face, or a combination thereof. The tag receiving logic may be operable to receive the at least one tag rule in response to establishment of a communication link between the apparatus and a host computer. A peripheral device, a camera, or a mobile phone may include the apparatus.

In general, in a third aspect, the invention features a computer program product that includes program code for re-assembling segments distributed across multiple repositories to form original data, the program code for generating at least one predicted tag rule, wherein the at least one tag rule is generated based upon information received from a data source, and the at least one tag rule is operable to associate a tag name with a content object in response to the content object satisfying the at least one tag rule, and communicating the at least one tag rule to a peripheral device for storage in a memory located on the peripheral device.

In general, in a fourth aspect, the invention features a computer program product that includes program code for re-assembling segments distributed across multiple repositories to form original data, the program code for receiving at least one tag rule, wherein the at least one tag rule includes a tag name, storing the at least one tag rule in a memory, and associating the tag name with a content object in response to the content object satisfying the at least one tag rule. Embodiments of the invention may include one or more of the following features. Associating the tag name with the content object may include storing an association between the tag name and the content object in the memory.

In general, in a fifth aspect, the invention features a computer-enabled method of associating tags with content objects. The method includes receiving at least one tag rule, wherein the at least one tag rule includes a tag name, storing the at least one tag rule in a memory, and associating the tag name with a content object in response to the content object satisfying the at least one tag rule. Embodiments of the invention may include one or more of the following features. Associating the tag name with the content object may include storing an association between the tag name and the content object in the memory. The method may further include displaying the tag name, and establishing an association between the tag name and the content object in response to a user accepting the association between the tag name and the content object.

### BRIEF DESCRIPTION OF THE DRAWINGS

The present application can be best understood by reference to the following description taken in conjunction with the accompanying drawing figures, in which like parts may be referred to by like numerals:

FIG. 1 is an illustrative drawing of tag preloading apparatus for loading tags onto a peripheral device in accordance with embodiments of the invention.

FIG. 2 is an illustrative drawing of tag preloading apparatus on a peripheral device in accordance with embodiments of the invention.

FIG. 3 is an illustrative flow diagram of a process for associating tag names with content objects in accordance with embodiments of the invention.

FIG. 4 is an illustrative drawing of an exemplary computer system that may be used in accordance with some embodiments of the invention.

### DETAILED DESCRIPTION

The following description is presented to enable a person of ordinary skill in the art to make and use the invention, and is provided in the context of particular applications. Various modifications to the embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention might be practiced without the use of these specific details. In other instances, well-known structures and devices are shown in block diagram form in order not to obscure the description of the invention with unnecessary detail. Thus, the present invention is not intended to be limited to the embodiments shown, but is to be accorded the widest scope consistent with the principles and features disclosed herein.

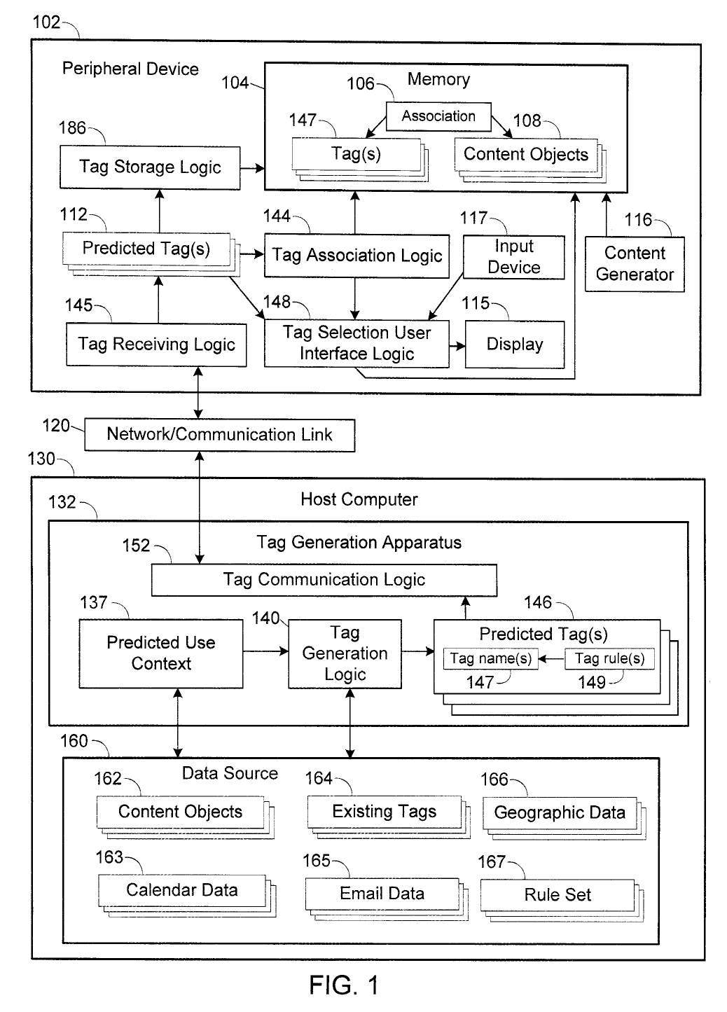

FIG. 1 is an illustrative drawing of tag preloading apparatus for loading tags onto a peripheral device in accordance with embodiments of the invention. A host computer, which is, for example, a computing system, includes or executes a tag generation apparatus 132. The tag generation apparatus 132 may be computer program code that, when executed by a processor, causes one or more tags to be selected, or generated, and loaded onto a peripheral device 102. Once a tag has been loaded onto the device 102, the tag may be associated with a content object such as a photograph, video, audio, or other content object. The peripheral device may be, for example, a camera, a cellular mobile phone, a portable digital assistant, or other portable device that interfaces with a communications network such as a cellular network or the Internet.

The tag generation apparatus 132 includes tag generation logic 140 for generating at least one predicted tag to be subsequently associated with a content object 108, wherein the predicted tag is based upon information received from a data source 160; and tag communication logic 152 for communicating the predicted tag(s) to the peripheral device via a communication network 120. The communication network 120 may be, for example, a wireless WiFi network, or a BlueTooth® network, or a USB (Universal Serial Bus) connection, or a wireless GSM or CDMA network, or any other type of connection for exchanging data between the host computer and the device 102.

In one example, the predicted tag(s) 146 include tag names 147, such as text strings that may be associated with content objects such as graphical images generated by a peripheral device. The content objects may be photos, audio, video, text, or any other type of data, as described below. The tag names 147 may include text, graphics (e.g., icons), or audio (e.g., voice representations of the text, or other voice or audio data). The tag names 147 may be names of events, e.g., events retrieved from an online calendar.

In another example, the tag generation logic 140 generates tag rules that define conditions under which tags may be applied to content objects on the device. The tag rules are loaded onto the device and the device processes the tag rules to determine which tags to apply to content objects. The tag rules allow the device to generate tag-object associations while disconnected from a network or server. The tag generation logic 140 may generate a tag rule 149 that includes a condition. The tag rule 149 specifies that the tag name 147 associated with the tag rule 149 is to be applied to content objects that satisfy the condition. The condition may be a conditional expression, a predicate, or similar entity that generates a value based upon attributes of a content object and other input values. An example tag rule 149 may specify that the tag names “U2” and “concert” are to be applied to photographs taken on June 25. The tag rule 149 may be loaded onto into the device 102 and processed by tag association logic 144 on the device, so that subsequently-created content objects 108, e.g., photographs, that satisfy the condition may be associated with the tag name 147 associated with the tag rule 149. For example, after the U2 tag rule has been loaded into the device 102, photographs taken on June 25 may be associated with the tags “U2” and “concert” by the tag association logic 144.

In one example, tag rules 149 may include locations, which may be specified as latitude-longitude coordinates, or as place names, or using any other notation for specifying geographic locations. In the case of place names, the tag association logic 144 may determine the geographic location of the place name by consulting a local geographic database, such as Yahoo!® Local. For example, a tag rule 149 may specify a tag name and a location name, such as a restaurant name. After the tag rule 149 has been loaded into the mobile device 102, content objects 108 taken in a geographic location at or near the location specified by the location name will be associated with the tag rule's name, e.g., the restaurant name.

The tag generation logic 140 may generate the predicted tags 146 based upon information received from the data source 160. The information received from the data source 160 may include content objects 162, e.g., photographs, audio files, and other types of media objects, calendar data 163, e.g., events associated with particular dates, existing tags 164, e.g., tags previously defined, email data 165, e.g., electronic mail messages to or from the user, geographic data 166, e.g., names and other information about geographic locations such as restaurants, museums, and any other locations, and optional tag rules 149 as described below.

The data source 160 provides information about events, e.g., in the form of calendar information 163 such as Personal Information Manager event data. For example, the calendar information 163 may include a U2 concert event with an associated date. Any content objects generated on the same date as the event may be tagged with names such as “U2” and “concert” by searching the database(s) for events, appointments, and the like that occurred on the day the content object (e.g., photo) was created. Geographic information may also be used to generate tags. In one example, geographic information, such as latitude and longitude coordinates, may be provided by a global positioning system (GPS) unit associated with the device 102, or may be deduced from the date associated with a content object and a location name associated with an event scheduled in the appointment database for that date.

The tag generation logic 140 may generate predicted tags 146 based upon a predicted use context 137. The predicted use context 137 may include information about the predicted use of the device 102, such as a predicted location, predicted events, predicted people, and other information relevant to the future use of the device. The predicted location may be based upon the calendar data 163 and the geographic data 166. For example, a location name that appears in both the calendar data 163 and the geographic data 166 is a likely predicted location to be visited on the dates specified in the calendar data 163. Similarly, a location name that appears in both the email data 165 and the geographic date 166 is a possible predicted location. A person's name that appears in both the content objects 162 and the calendar data 163 or email data 165 is an example of a predicted person's name. An event name that appears in the calendar data 163 for a future date is an example of a predicted event. In one example, these predicted values are provided to the tag generation logic as the predicted use context 137. The tag generation logic 140 may use the predicted use context 137 to determine which information from the data source 160 to use when generating the predicted tags 146. For example, the tag generation logic 140 may generate predicted tags 146 by selecting tag names or strings from the existing tags 164 that match at least one of the predicted values in the predicted use context 137. Similarly, the tag generation logic 140 may generate predicted tags 146 based upon the predicted use context 137. For example, an entry named “Lunch at Ferry Building with Joe on July 10” in the calendar data 163 may cause the tag generation logic 140 to generate the tag names “lunch”, “Ferry Building”, “Joe”, and a tag rule associated with those tags and having the condition “date=July 10”, which specifies that the tags “Lunch”, “Ferry Building”, and “Joe” are to be applied to content objects subsequently created by the content generator 116. These tag names 147 and tag rule(s) 149 are transferred to the device 102 via the network 120. The device 102 may subsequently apply these tags to content objects that satisfy the condition.

In one example, the tag generation logic 140 may select the predicted tag 146 from a database of existing tags 164. In this example, the predicted use context 137 determines which tags are selected from the existing tags 164.

In one example, as introduced above, the tag generation logic 160 may generate tags based upon a predicted use context 137. The predicted use context may include information such as existing associations between tags and content objects or other information in the database, and may also include information about the peripheral device 102, such as locations visited or planned to be visited by the user of the peripheral device 102, or content generated by the peripheral device 102, or calendar entries in the peripheral device 102, or transactions performed on the peripheral device 102.

In one example, tag receiving logic 145 on the device 102 receives the tag(s) 146 via the communication network 120. Tag storage logic 186 may store the tag(s) 146 in the memory 104. Once the tag(s) 146 have been stored in the memory, they may be subsequently associated with one or more content objects 108 by tag association logic 144. An association 106 between a tag 146 and a content object 108 may be stored in the memory 104 as, for example, a reference to a tag, where the reference is stored in a data structure that represents the content object 108, or vice versa, or as an entry in an association table 109, such as a pair (tag, content object).

In one example, the tag association logic 144 stores an association between the each of the tags 144 and a corresponding content object 108. The content object 108, or a reference to the object 108, such as the object's name or identifier, is received by the tag receiving logic 145 from the tag generation apparatus via the network along with the tags 146. The tag communication logic 152 located on the tag generation apparatus 132 sends the content object(s) 108 along with the associated tags 146 to the device 102. The content object(s) 108 may be part of the information upon which the tags(s) 147 are selected for association by the tag association logic 144.

In one example, the association between the tag(s) 147 and the content object(s) 108 may be established by a user, who views content objects and predicted tags 112 on a display 115 of the peripheral device, and may select, using an input device 117, particular tags from the list of predicted tags 146 to be associated with particular content objects. Each such selection establishes an association 106 between a content object 108 and a tag name 147, and the association 106 is stored in the memory 104. The predicted tags 112 are a representation of the predicted tags 146 received by the device 102 from the host computer 130.

In one example, a name portion of a tag 112 may be associated with a content object 108 created by the content generator 116 by storing the tag name in the content object file, e.g., for a photograph, the name of the tag 112 may be stored in the photo file's Exchangeable image file format (Exif) header. In another example, a tag 112 may be stored in an internal representation in the device 102, such as in an association table that includes an association entry for each tag-content object association. For example, the tag association logic 144 may create the Exif header entry or the association entry upon receiving the tag 112 from the tag receiving logic 145, or upon determining that a tag rule's condition is true for a particular content object 108. In one example, if the tag association logic 144 determines that a tag rule condition is true, then the tag association logic 144 associates the name portion of the tag 147 with the content object 108.

In another example, the tag selection user interface 148 may query a user (not shown) by presenting a tag 112 and a content object created by the content generator 116 on a display 115. The user may select one or more of the tags 112 to be associated with the content object. The tag association logic 144 may then store the selected tags 147 in the Exif headers of the corresponding content objects, or association entries 111 may be created for the selected tag(s) 147 and content object(s) 108, or the association may be established using any other appropriate data representation.

In one example, the tag generation logic 140 generates the predicted tag(s) 146, including the tag rules 149 and associated tag names 147, based upon information provided by a data source 160. The information may be, for example, an image, video, audio, a calendar information, a transaction record, a geographic location, geographic location information such as that provided by Yahoo!® Local, input data provided by a user of the peripheral device 102, or a tag.

In one example, if the information provided by the data source 160 represents a geographic location, e.g., a name of a place, a latitude, longitude, or any other reference to a location, then the following tags may be generated: the name of the location (e.g., “Paris”), the name of landmarks known to be near the location according to a landmark database (e.g., “Eiffel Tower” for a location near the Eiffel Tower). If a date is associated with the location, then a tag may be generated for the location based on the date (“e.g., June”), or a tag may be generated based on a calendar entry from an electronic calendar system, using the date on which the location was visited (e.g., “Trip to Paris”).

The geographic location may be a place referenced in an operation performed on the peripheral device. The operation may be transaction, a display of information, or a global positioning system query. The input data may be a location name, an event name, a person's name, or a landmark name.

In one example, the tag generation logic 140 may generate the tags 146 based upon a trip plan received from the data source 160. A trip plan is, for example, a list of locations to be visited on a trip, as described in the U.S. patent application titled Interactive Map-Based Travel Guide, Ser. No. 11/263,623, the contents of which are incorporated herein by reference in their entirety. Tags based on the trip plan may be preloaded into the memory 104 of the peripheral device 102, e.g., prior to the trip, so that the tags are available on the device to be associated with content objects, e.g., when new content objects are created during the trip. The tag generation logic 140 generates predicted tags 146 based on the trip plan by using the location-based prediction technique described above for each location, event, and date in the trip plan. The tag communication logic 152 then sends the predicted tags 146 generated for the locations, events, and dates in the trip plan to the peripheral device 102. The tags 146 are received on the peripheral device 102, on which they are referred to herein as predicted tags 112. As described above, the tags 112 are received on the peripheral device 102 by tag receiving logic 145, which may forward the tags 112 to tag storage logic 186 for storage in a memory 104. The tags 112 are then available for use on the device 102 by the tag association logic 144, which may automatically associate tags with content objects by, for example, evaluating the rule portion of a tag 112 and associating the name of the tag 112 with objects that satisfy the rule. For tags 112 that do not include a rule, the association logic 144 may establish an association between the tag 112 and any content object 108 on the device. For tags that include a rule, the association logic 144 evaluates the rule, possibly with a content object as input to the rule evaluation process. If the rule is satisfied for a particular content object, then the tag association logic 144 may associate the rule's associated tag name with the object automatically, or, alternatively, may query the user, and allow the user to decide whether to associate the tag name with the content object. In the automatic association case, the association is established without interacting with the user. In the user query case, the tag selection user interface logic 148 may prompt the user to accept the association of a tag name with a content object.

The rule condition may include a logical expression of one or more variables, and the tag generation logic 140 may generate a predicted tag 146 with the value of the tag rule 147 in response to the rule condition being true, i.e., when the condition is satisfied. A variable may represent an attribute of an image, such as a date, time, geographic location, resolution, or any other property associated with an image or a content object. Content objects 162 against which a rule will be evaluated may be provided by the data source 160. A variable may also represent a location or a name of a location. Location information against which a rule may be evaluated may be may be provided by the data source based on the geographic data 164. A variable may also represent a date or a time. Time-based event information against which a rule may be evaluated may be provided by the data source 160 based on the calendar data 163. A variable may also represent a property of an image, or graphical characteristic of an image, such as a defined pattern, a face, or a combination thereof.

For example, a rule may state that the tag name U2 is to be applied to any photograph taken on June 25. The rule may be represented as:

U2(date( )=June 22)

In this example, if a content object is generated by the content generator 116 on the device 102, and the U2 tag rule is present on the device 102 (e.g., stored in the memory 104), then the tag association logic 144 will associate the tag name “U2” with a content object if the content object is dated June 22.

In another example, if a content object is generated by the content generator 116 on the device 102, and a tag rule is present on the device 102 (e.g., stored in the memory 104), then the tag association logic 144 will associate the tag name, e.g., “Duomo”, with a content object if the content object has a geographical location attribute and the location attribute specifies a given location, e.g., a location near 43°46′24″N 11°15′22″E which is the location of the Duomo.

The logical expression in a rule condition may also refer to characteristics of the image provided by functions, such as a function that determines whether the image contains a face. For example, a rule may specify that a tag name “Tanya” is to be generated for each photograph taken by the device 102 on a Friday if the photograph image includes an image of a face. The face feature is detected by a pattern recognition function applied to the photograph image. The day on which the photograph was taken is specified in the rule expression by, for example, a date attribute associated with the photograph's image file. Therefore, the example tag rule may be represented as:

Tanya(image.date( )=Friday and image.hasFace( ))

where Tanya is the tag name and “image.date( )=Friday and image.hasFace( )” is the rule condition.

As another example, a rule may specify that the tag name Paris is to be applied to images that were taken when the phone was in the vicinity of the geographic location of Paris:

Paris(image.latitude( ) near “48.48N” and image.longitude( ) near “2.20E”)

The latitude and longitude attributes of the photograph image in this example are latitude and longitude values read from the peripheral device's GPS receiver when the photograph was taken.

In one example, the rule set 167 may be updated based upon information such as existing tags 164 and content objects 162. Association of a tag 147 with a content object 108 on the peripheral device 102, by the tag association logic 144 or by the tag selection user interface logic 148, for example, may provide a basis for creation of a new rule in the rule set 167. The new rule may specify that a tag with the value of the tag 147 is to be created when a condition derived from the content object 108 is satisfied.

In one example, once the tags 146 have been generated, they are loaded onto the device 102 in response to a communication link being established between the peripheral device 102 and the tag generation apparatus 132 (e.g., the host computer 130). For example, the tags 146 may be loaded when a BlueTooth® connection, a Universal Serial Bus (USB) connection, or any other type of communication link is established between the device 102 and the host computer 130. In this example the tags are sent to the peripheral device 102 via the communication link. Tag-content object associations may also be sent from the tag generation apparatus 132 to the device 102 via the communication link, in which case references to content objects that correspond to a tag may be sent along with the tag, so that the association may be established on the device, e.g., by storing the association in the device memory 104.

Since the tags 147 (and optionally, the associations 106 with content objects 108) are stored in the memory 104, the tags remain accessible by the peripheral device 102 after disconnection of the device 102 from the apparatus 132 (i.e., from the host computer 130). Disconnection refers to closing of the communication link, e.g., by physical disconnection of a cable, or closing of a wireless connection, or physical disconnection of the device from the hot computer, or severing of the communication link for any reason. The tag generation apparatus 132 may be part of a computer, camera, mobile phone, or other electronic device.

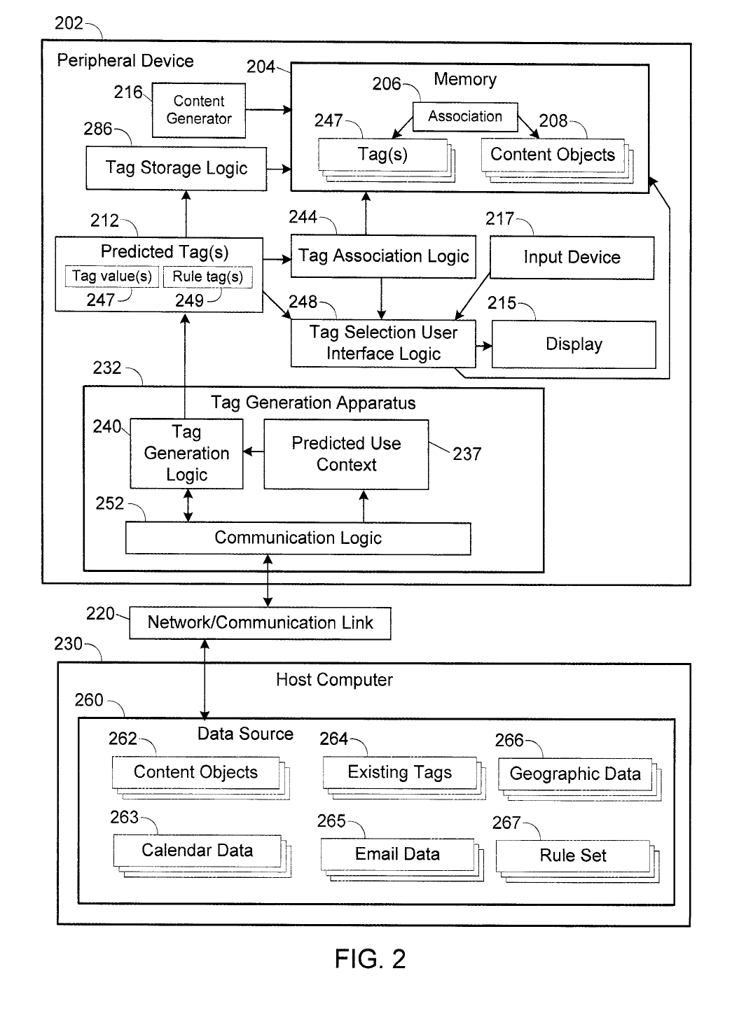

FIG. 2 is an illustrative drawing of tag preloading apparatus on a peripheral device 202 in accordance with embodiments of the invention. Tag generation logic 240 may execute on a peripheral device 202 to generate tags 212 and store the tags 212 in a memory 204 on the peripheral device 202. Each tag 212 includes a tag name 247 which may be associated with an optional rule tag 249. Tag association logic 244 on the device 204 may create an association 206 between predicted tag(s) 212 and information, such as content objects 208, and store the association 206 in the memory 204, as described above with reference to the tag association logic 144 of FIG. 1. The tags 212 may be stored in the memory 204 as tags 247 and associated with content objects 208, and associations 206 between the tags 247 and the content objects 208 may also be stored in the memory 204. In one example, the association 206 may be stored in the Exif header of the content objects 208. Tag storage logic 286 stores the tags 212 in the memory 204. The tag generation logic 240 generates tags 212 based on information received from a data source 260 as described above with respect to FIG. 1. However, in FIG. 2, since the tag generation logic 240 is located on the peripheral device 202, the tags 212 need not be sent to the device 202 via the communication network. Instead, information provided by the data source 260 may be sent via the network 220 from a host computer 230 to the peripheral device 202 for use as input to the tag generation logic 240. Input to the tag generation logic 240 may also be retrieved from the memory 204 located on the device 202, so the tag generation logic 240 is independent of the host computer 230 in some examples. If a network connection has been established between the peripheral device 202 and the host computer 230, and the data source 260 is available, then the tag generation logic 240 will retrieve information from the data source 260 for use in generating tags as described above with respect to FIG. 1.

Tag selection user interface logic 248 on the device 204 may display predicted tag(s) 212 and receive selection from a user of at least one selected tag selected from the at least one predicted tag by the user. The tag selection user interface logic 248 may then establish an association between the selected tag with and the content object 208, e.g., by storing an association between the at least one predicted tag and the content object 208 in the memory.

As described above with respect to FIG. 1, the tag generation logic 240 may generate the predicted tag(s) 212 in response to a condition of a rule tag 249 being true. The peripheral device 30 may be, for example, a camera, a mobile phone, a computer, a personal digital assistant, or any other electronic device.

In one example, the tag communication logic 152 loads tags onto peripheral devices when the peripheral devices are coupled to an intermediary device that does have access to the tagging system. For example, a camera generally does not possess tag suggestion logic or have access to a tagging system. When a camera is connected to a PC, however, tags may be loaded onto the camera through the PC. In this exemplary scenario, the camera represents the peripheral device and the PC acts as the intermediary device. The tags loaded onto the camera generally are suggested tags for the content already stored or likely to be stored on the camera. Each suggested tag preferably comprises a location associated with the user of the camera, such as the user's home address, place of business, most frequent retreat, or any other locations related to the user. Although a location tag was used for the suggested tag in the previous example, other types of tags that may be associated with the content stored in the peripheral device.

In one example, tags 112 may be preloaded onto a peripheral device via an intermediary device (not shown). The peripheral generally will have the capacity to generate content, such as audio and video. At this point in the procedure the content is untagged because the peripheral device has no access to a tagging system. Although audio and video is the most prevalent type of tagged content, the other types of data sources may be used, including web pages, wikis and blogs.

In one example, the peripheral device may be coupled to the intermediary device. The intermediary device may comprise any type of device that facilitated the exchange of information from the peripheral device to the tagging system. This connection may be manual, i.e., when a user manually connects the peripheral device to the intermediary device, or the connection may be automatic, e.g., the peripheral device automatically couples itself to intermediary device at a predetermined time though a predetermined connection.

Once the connection between the peripheral device and the intermediary device has been established, the tag generation logic 140 generates tags for the content 108 stored on the peripheral device 102. This tagging system's suggestion process may operate independent from the peripheral device without any information from the peripheral device, or alternatively, may suggest tags based on information stored on the peripheral device, such as the size and creation time of the content stored on the peripheral device. After the tag generation logic 140 creates suggested tags for the peripheral device, these tags may be transferred to the peripheral device 102 through the intermediary device.

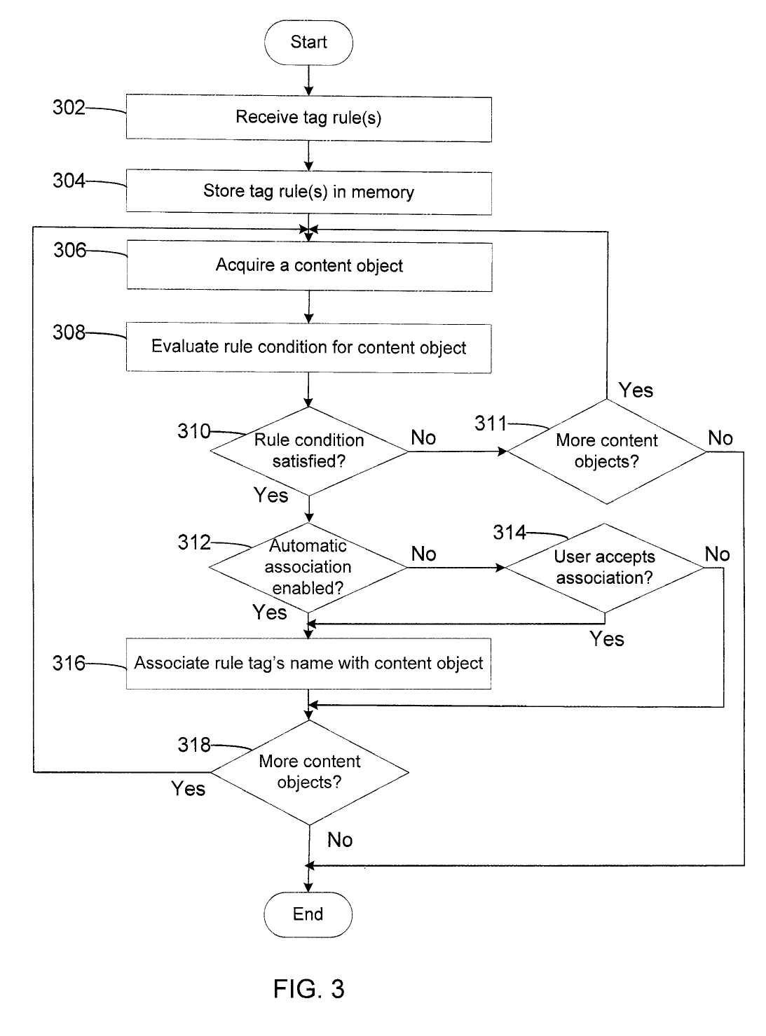

FIG. 3 is an illustrative flow diagram of a process for associating tag names with content objects in accordance with embodiments of the invention. The process of FIG. 3 may be executed by a mobile device such as a cellular phone, a camera, a personal digital assistant, a laptop computer, or the like. The process may be, for example, computer program code stored in a computer readable medium. Block 302 receives tag rule(s) from a host system. Block 304 stores the received tag rule(s) in a memory of the mobile device. Block 306 begins the evaluation of a rule. Note that the process may be extended to evaluate multiple rules by repeating the process starting at block 306 for each rule. Block 306 acquires a content object such as a photographic image file, an audio file, a video file, or any other type of media object stored in a memory accessible by the mobile device. Block 308 evaluates the rule condition for the content object acquired in block 306. The rule condition may be based upon, for example, attributes and/or visual features of the content object. Block 308 therefore may perform content analysis on the content object, such as image recognition to identify features such as faces, or voice recognition on audio or video files, or any other type of analysis of the image to produce a result for use in a rule condition. Block 308 may also extract attributes of the content object such as a location associated with the object, e.g., a geographic location in which a photo was taken. Block 310 determines if the rule condition is satisfied, i.e., if the rule condition evaluates to true for the current content object. If block 310 determines that the rule condition is not satisfied, block 311 determines if there are more content objects. If so, block 306 acquires another content object at block and repeats the previously-described steps. If there are no more content objects to process, block 311 transfers control to the End block and the process terminates.

If block 310 determines that the rule condition is satisfied, then block 312 determines if automatic association of tags to content objects is enabled, i.e., permitted or configured to occur, for the current content object and rule. In other examples, the automatic association may be enabled or disabled independently of a particular content object or rule, or may be determined by configuration information provided by the user, or by any other configuration information or condition. If block 312 determines that automatic association is disabled, then block 312 determines if the user approves the association of the tag name with the content object. Block 312 may display a user interface, such as a dialog box or check box, which the user may interact with to accept or reject the association of the tag name with the content object. If the user accepts the association, block 316 establishes the association, e.g., by storing a pointer or table entry in memory to link the tag name with the content object, or by storing the tag name in the content object, e.g., in an Exif header of the content object. Block 318 then determines if there are more content objects to process. If so, the process repeats, starting at block 306. If block 312 determines that automatic association is disabled, and the user does not accept the association, then the association is not created. If block 318 determines that there are no more content objects to process, the process terminates.

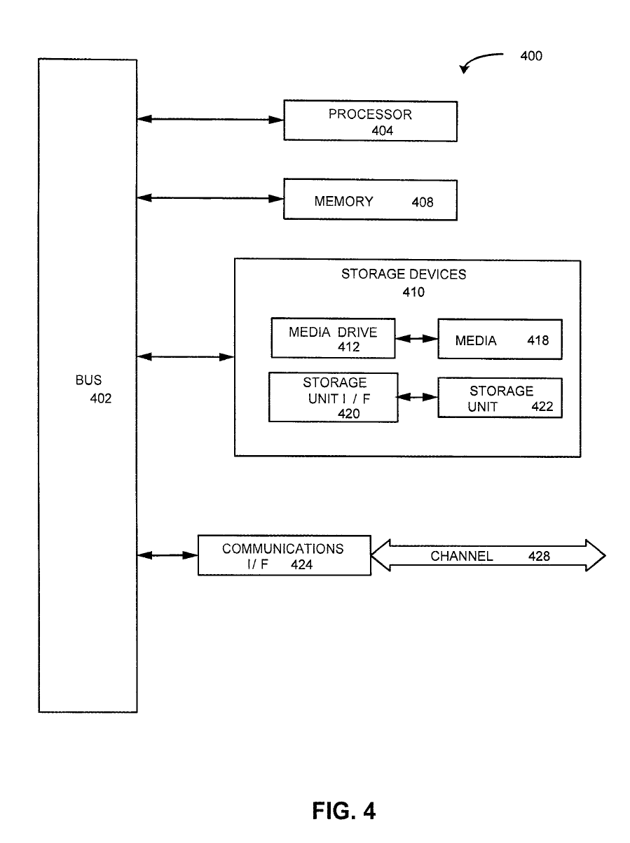

FIG. 4 is an illustrative drawing of an exemplary computer system that may be used in accordance with some embodiments of the invention. FIG. 4 illustrates a typical computing system 400 that may be employed to implement processing functionality in embodiments of the invention. Computing systems of this type may be used in clients and servers, for example. Those skilled in the relevant art will also recognize how to implement the invention using other computer systems or architectures. Computing system 400 may represent, for example, a desktop, laptop or notebook computer, hand-held computing device (PDA, cell phone, palmtop, etc.), mainframe, server, client, or any other type of special or general purpose computing device as may be desirable or appropriate for a given application or environment. Computing system 400 can include one or more processors, such as a processor 404. Processor 404 can be implemented using a general or special purpose processing engine such as, for example, a microprocessor, microcontroller or other control logic. In this example, processor 404 is connected to a bus 402 or other communication medium.

Computing system 400 can also include a main memory 408, such as random access memory (RAM) or other dynamic memory, for storing information and instructions to be executed by processor 404. Main memory 408 also may be used for storing temporary variables or other intermediate information during execution of instructions to be executed by processor 404. Computing system 400 may likewise include a read only memory (“ROM”) or other static storage device coupled to bus 402 for storing static information and instructions for processor 404.

The computing system 400 may also include information storage system 410, which may include, for example, a media drive 412 and a removable storage interface 420. The media drive 412 may include a drive or other mechanism to support fixed or removable storage media, such as a hard disk drive, a floppy disk drive, a magnetic tape drive, an optical disk drive, a CD or DVD drive (R or RW), or other removable or fixed media drive. Storage media 418, may include, for example, a hard disk, floppy disk, magnetic tape, optical disk, CD or DVD, or other fixed or removable medium that is read by and written to by media drive 414. As these examples illustrate, the storage media 418 may include a computer-readable storage medium having stored therein particular computer software or data.

In alternative embodiments, information storage system 410 may include other similar components for allowing computer programs or other instructions or data to be loaded into computing system 400. Such components may include, for example, a removable storage unit 422 and an interface 420, such as a program cartridge and cartridge interface, a removable memory (for example, a flash memory or other removable memory module) and memory slot, and other removable storage units 422 and interfaces 420 that allow software and data to be transferred from the removable storage unit 418 to computing system 400.

Computing system 400 can also include a communications interface 424. Communications interface 424 can be used to allow software and data to be transferred between computing system 400 and external devices. Examples of communications interface 424 can include a modem, a network interface (such as an Ethernet or other NIC card), a communications port (such as for example, a USB port), a PCMCIA slot and card, etc. Software and data transferred via communications interface 424 are in the form of signals which can be electronic, electromagnetic, optical or other signals capable of being received by communications interface 424. These signals are provided to communications interface 424 via a channel 428. This channel 428 may carry signals and may be implemented using a wireless medium, wire or cable, fiber optics, or other communications medium. Some examples of a channel include a phone line, a cellular phone link, an RF link, a network interface, a local or wide area network, and other communications channels.

In this document, the terms “computer program product,” “computer-readable medium” and the like may be used generally to refer to media such as, for example, memory 408, storage device 418, or storage unit 422. These and other forms of computer-readable media may be involved in storing one or more instructions for use by processor 404, to cause the processor to perform specified operations. Such instructions, generally referred to as “computer program code” (which may be grouped in the form of computer programs or other groupings), when executed, enable the computing system 400 to perform features or functions of embodiments of the present invention. Note that the code may directly cause the processor to perform specified operations, be compiled to do so, and/or be combined with other software, hardware, and/or firmware elements (e.g., libraries for performing standard functions) to do so.

In an embodiment where the elements are implemented using software, the software may be stored in a computer-readable medium and loaded into computing system 400 using, for example, removable storage drive 414, drive 412 or communications interface 424. The control logic (in this example, software instructions or computer program code), when executed by the processor 404, causes the processor 404 to perform the functions of the invention as described herein.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

Moreover, it will be appreciated that various modifications and alterations may be made by those skilled in the art without departing from the spirit and scope of the invention. The invention is not to be limited by the foregoing illustrative details, but is to be defined according to the claims.

Although only certain exemplary embodiments have been described in detail above, those skilled in the art will readily appreciate that many modifications are possible in the exemplary embodiments without materially departing from the novel teachings and advantages of this invention. Accordingly, all such modifications are intended to be included within the scope of this invention.

What is claimed is:

1. A tag generation apparatus for preloading tag rules onto a peripheral device, the apparatus comprising:
tag generation logic for generating at least one tag rule, wherein the at least one tag rule is generated based upon information received from a data source, and the at least one tag rule is operable to associate a tag name with a content object in response to the content object satisfying the at least one tag rule; and
tag communication logic for communicating the at least one tag rule to the peripheral device for storage in a memory located on the peripheral device.

2. The apparatus of claim 1, wherein the information comprises an image, video, audio, a calendar entry, a transaction record, a geographic location, input data provided by a user of the peripheral device, an existing tag, or a combination thereof.

3. The apparatus of claim 2, wherein the input data comprises a location name, an event name, a person's name, a landmark name, or a combination thereof.

4. The apparatus of claim 2, wherein the geographic location comprises a place referenced in an operation performed on the peripheral device.

5. The apparatus of claim 4, wherein the operation comprises a transaction, a display of information, a global positioning system query, or a combination thereof.

6. The apparatus of claim 1, wherein the tag name comprises text, graphics, audio, or a combination thereof.

7. A tag association apparatus for associating tags with content objects, the apparatus comprising:
tag receiving logic for receiving at least one tag rule, wherein the at least one tag rule includes a tag name;
a memory for storing the at least one tag rule;
tag storage logic for storing the at least one tag rule in the memory; and
tag association logic for associating the tag name with a content object in response to the content object satisfying the at least one tag rule.

8. The apparatus of claim 7, wherein the tag association logic is operable to store an association between the tag name and the content object in the memory.

9. The apparatus of claim 7, further comprising:
tag selection user interface logic for displaying the tag name, wherein the tag selection user interface logic is operable to cause the tag association logic to establish an association between the tag name and the content object in response to a user accepting the association between the tag name and the content object.

10. The apparatus of claim 7, wherein the tag association logic is operable to associate the tag name with the content object in response to receiving the content object from a content generator and the content object satisfying the at least one tag rule.

11. The apparatus of claim 7, wherein the at least one tag rule comprises a logical expression having at least one variable, and the tag association logic is operable to associate the tag name with the content object in response to the logical expression being true.

12. The apparatus of claim 11, wherein the at least one variable represents at least one attribute of an image.

13. The apparatus of claim 12, wherein the at least one attribute comprises a date, a time, a place, a feature of the image, or a combination thereof.

14. The apparatus of claim 11, wherein the at least one variable represents at least one graphical characteristic of an image.

15. The apparatus of claim 14, wherein the at least one graphical characteristic comprises a defined pattern, a face, or a combination thereof.

16. The apparatus of claim 7, wherein the tag receiving logic is operable to receive the at least one tag rule in response to establishment of a communication link between the apparatus and a host computer.

17. A peripheral device comprising the apparatus of claim 7.

18. A camera comprising the apparatus of claim 7.

19. A mobile phone comprising the apparatus of claim 7.

20. A computer program product comprising program code for re-assembling segments distributed across multiple repositories to form original data, the program code for:
generating at least one predicted tag rule, wherein the at least one tag rule is generated based upon information received from a data source, and the at least one tag rule is operable to associate a tag name with a content object in response to the content object satisfying the at least one tag rule; and
communicating the at least one tag rule to a peripheral device for storage in a memory located on the peripheral device.

21. A computer program product comprising program code for re-assembling segments distributed across multiple repositories to form original data, the program code for:
receiving at least one tag rule, wherein the at least one tag rule includes a tag name;
storing the at least one tag rule in a memory; and
associating the tag name with a content object in response to the content object satisfying the at least one tag rule.

22. The computer program product of claim 21, wherein associating the tag name with the content object comprises storing an association between the tag name and the content object in the memory.

23. A computer-enabled method of associating tags with content objects, the method comprising:
receiving at least one tag rule, wherein the at least one tag rule includes a tag name;
storing the at least one tag rule in a memory; and
associating the tag name with a content object in response to the content object satisfying the at least one tag rule.

24. The method of claim 23, wherein associating the tag name with the content object comprises storing an association between the tag name and the content object in the memory.

25. The method of claim 23, further comprising:
displaying the tag name; and
establishing an association between the tag name and the content object in response to a user accepting the association between the tag name and the content object.
